(19) United States
(12) Patent Application Publication
(10) Pub. No.: US 2008/0111687 A1
(43) Pub. Date: May 15, 2008

(54) Means to deter intruders intending to breach an outdoor barrier such as a fence or wall utilizing a repulsive odor spray and a colored dye actuated by electronic perimeter security sensor systems that have the means to identify the specific breach location

(76) Inventor: Robert John Husmann, Soquel, CA (US)

Correspondence Address: ROBERT J. HUSMANN, P.O. BOX 66, CAPITOLR, CA, 95010, US

(21) Appl. No.: 11/981,176

(22) Filed: Oct. 31, 2007

Related U.S. Application Data
(60) Provisional application No. 60/857,232, filed on Nov. 7, 2006.

(51) Int. Cl. B05B 9/00; G08B 13/00; G08B 13/18

(52) U.S. Cl. 340/552; 340/541; 340/550; 222/78

(57) ABSTRACT

An invention that repels intruders from breaching large outdoor perimeter security systems consisting of an exterior physical barrier such as a fence or wall in combination with electronic sensors that detects the breach attempt and can identify the location of the attempt within a few feet. When detection occurs, the system activates a plumbing distribution and emission system that emits a repellent substance in the specific area or zone of the intrusion. The emission has a repulsive odor and an optional color dye that covers the intruders' clothing causing the intruders to abandon the attempted breach. The emission is neither painful nor dangerous to the health of the intruder but facilitates dog tracking. When activated, the system also normally sends an alarm to a Central Control Center, said alarm including the breach attempt location.

### CROSS-REFERENCES TO RELATED APPLICATION

This application claims the benefit of PPA SER. No. 60/857,232 filed Nov. 6, 2006 by the present inventor, which is incorporated by reference.

### BACKGROUND

This invention relates to a means of creating a deterrence for intruders who have the intent to breach a large outdoor perimeter security system, said means including the dispensing of a benign repellent and/or color dye using sophisticated sensor systems that identify the exact area of the intrusion.

The invention was conceived as a result of studying the problem regarding the failure to stop illegal immigration along the US Borders. The invention was conceived because of the realization that the typical perimeter security methods of barrier fences and intrusion sensors in use today are ineffective on the Border because there is no meaningful deterrence. Illegal intruders can breach the perimeter knowing that there is a good possibility that they will succeed and, if apprehended, they will simply be sent back across the Border. Without some means of high deterrence, the illegal intruders will never be inhibited from finding ways to breach Border fences and intrusion sensors. The politics associated with immigration preclude the use of deterrents that are physically harmiful to the immigrant intruder. Yet, without deterrents and because of the length and remoteness of the Border fences, there is nothing to stop the intruders from using sophisticated breaching aids to breach and/or vandalize both the barrier and sensor systems.

### SUMMARY

The purpose of this invention is to provide a strong deterrence to anyone who intends to intrude into or through a legal line of demarcation such as a fence, wall or similar barrier. The invention comprises a unique combination of existing components and sub-systems, that, when properly integrated, will discourage and repel an intruder from breaching a perimeter fence.

Specifically, this invention uses an offensive, repulsive substance such as a spray or other type emission that, when emitted on or near the intruders will act as a deterrent and repel the intruders. It also uses a unique type of sensor system that can identify the location of the breach attempt within a few feet.

### DRAWINGS

FIG. 1 is a schematic of one embodiment of the invention. This embodiment is associated with the use of the invention on a relatively small perimeter security system consisting of approximately one mile of fence or less. The schematic depicts only three-ten foot zones of the perimeter fence. It will be obvious to the reader that the components and operation shown by the schematic could be expanded to a much larger plurality of zones and that the assembly of the components could be modified in many ways and still be within the intent of the invention.

The depicted fence is comprised of fence posts (1) and fence fabric (2). The repellent substance (3) would be stored in some type of container such as a tank or canister (4). The repellent substance would be pressurized in some manner such as an in-line pump (5), by pressurized gas, by gravity or some other appropriate means.

The pressurized repellent substance (3) in the canister (4) and the primary flow pipe (6) is normally quiescent. When an intruder activates a sensor (8) in one of the zones, the sensor electrically actuates an electromechanical flow control valve (7) via electrical wire (9) allowing the fluid substance to flow from the canister (4) into the secondary pipe (10). Electromechanical valves (7) are distributed in the primary pipe so that one valve is located in each zone.

The secondary pipe has small holes or nozzles (11) that permit the sprayed substance (12) to be released upon the intruder. When the sensor is no longer activated or times out, the flow control valve (7) returns to its normally closed state and the emission stops. The nozzles can be of any type or may simply be small apertures in the pipe itself. The sensors and valves are powered by external sources via signal/power cable (13).

FIG. 2 provides a more complex embodiment of my invention as would be required to provide deterrence associated with the perimeter fence of a larger, high security perimeter security installation. Such installations, e.g., a national border or military establishments require one or more remote Central Control Points. The schematic is representative of the many designs and components that would be customized for specific applications. Each such security installation would be engineered to meet the user's specific security threats and need to interface with other aspects of their total security system. The almost infinite design variations do not impact on the novelty and intent of the invention itself, i.e., a novel and unique way to create a strong perimeter security deterrence so as to diminish the probability that intruders would attempt to breach a perimeter security fence or other barrier.

The primary change in the FIG. 2 embodiment is that the system in FIG. 2 incorporates a Supervisory Control And Data Acquisition (SCADA) system to facilitate the more complex operation of the system, a function that would be required if the perimeter to be protected was lengthy and/or had to interface with other subsystems such as video assessment, alarm notification systems and breach location information.

A SCADA system is a common component of any complex security system. It uses a Programmable Logic Controller (PLC), a specialized digital computer that is programmable and acts as the “brain” of the system. The PLC can be programmed to monitor and react to an event and automatically initiate other actions in the system. It can also notify a remote human operator(s) who can take pre-determined actions.

Additionally, this embodiment utilizes sensor systems that have discrete location capabilities. This sensing technique is available in several forms. One such form comprises sensors, each of which has an individual code. These codes are attached to the alarm transmission so that the sensor location can be identified.

Recently “linear” sensors utilizing fiber-optic or coaxial cables have been developed that can identify the location of an anomaly within the cable (such as distortion, vibration or compression) within a few feet. The length of such cables can be many miles long, which makes the cost per foot a fraction of discrete encoded sensors.

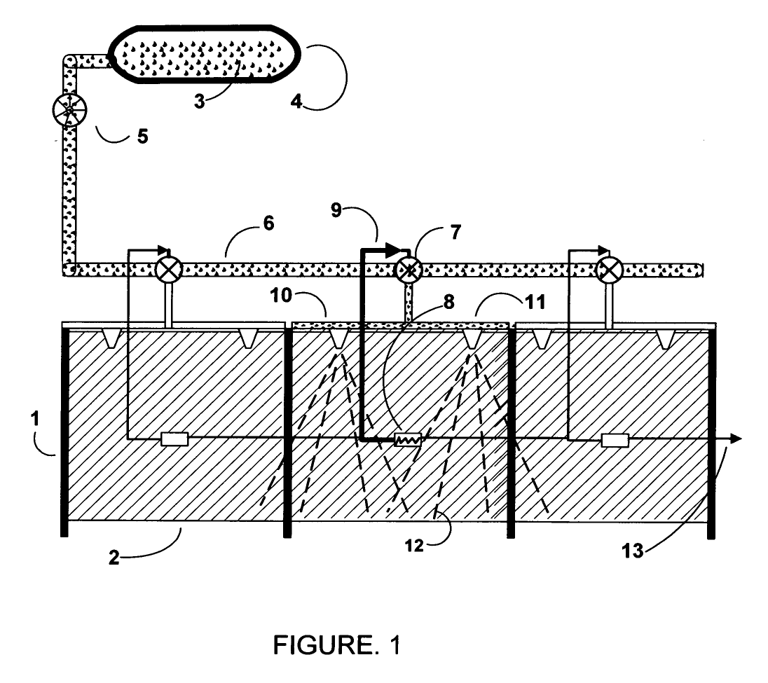

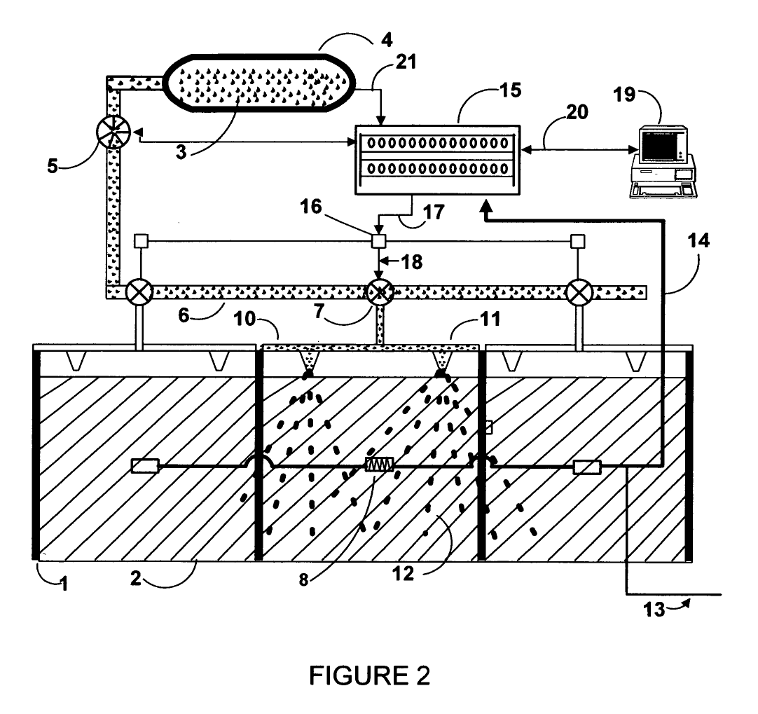

In FIG. 2, it can be seen that sensors (8) report an intrusion attempt via a data link (14) to an electronic PLC (15) rather then directly actuating the flow control valve (7) as seen in FIG. 1. The PLC is programmed to actuate a solenoid (16) via data link (17) that, in turn, actuates the proper zone flow control valve (7) via data link (18). The PLC also communicates the control valve actuation event to a Central Control point (19) via a data link (20). Other system component status, e.g., repellent quantity in container (4), also communicated by a data link (21) to the PLC and is relayed to Central Control (19). Power for the entire system is supplied from an exterior source via cable (13).

The schematic drawings in FIGS. 1 and 2 show sensors as rectangular boxes—Item (8). Those boxes depict any type of sensor and can be placed at any location on the barrier consistent with their anomaly detection characteristics.

The SCADA system and the PLC or their equivalents are common components in all large security intrusion systems and other complex command and control applications such as automatic fire suppressant systems. Although, they are within the state-of-the-art, they are shown here to demonstrate that my invention has broad applications to both small and large perimeter security systems, e.g., from prison yard perimeters (small) to International Borders (large).

### Legends for FIGS. 1 and 2

1. Fence Post
2. Fence Fabric e.g. chain link
3. Fluid or substance in tank
4. Holding Tank
5. Fluid Pump or Compressor
6. Primary Distribution Pipe
7. Electrically Controlled On/Off Valve
8. Electronic Sensor for Sensing Fence Disturbances
9. Circuit from Sensor to On/Off Valve for small perimeters
10. Secondary Distribution Pipe
11. Nozzle or Hole for Fluid Spray
12. Spray from Nozzle
13. Power Cable for Electrical/Electronic Components from Electrical Source
14. Data line from Sensor to Programmable Logic Controller
15. Programmable Logic Controller (PLC)
16. Solenoid that actuates On/Off Fluid Control Valve
17. Electrical Circuit from PLC to Solenoid
18. Electrical Circuit from Solenoid to On/Off Fluid Control Valve
19. Remote Central Control Station
20. Data Line Between PLC and Remote Central Control Station
21. Electrical Circuit from Tank to PLC representing other System Inputs.

### DESCRIPTION

Typically, an exterior intrusion barrier system employs a physical barrier such as a fence and a sensor system that detects some anomaly at or near the point of someone intruding by breaking through or climbing the barrier. The activated sensor sends an alarm signal to some remote station that takes appropriate action. In my invention, the sensor system not only sends an alarm notification, but also activates a plumbing distribution and emission system that sprays or emits a repellent substance in the area or zone of the intrusion. This emission has an offensive, repelling odor and optional color die that covers the intruder's clothing causing the intruder to abandon the breaching attempt. Further, the sensor system is capable of determining the location of the breach attempt within a few feet so that the emission is limited to that pre-designated zone.

The emission does not cause pain or precipitate a negative health condition. If color is also employed, the intruder becomes prominently identifiable.

The substance that is emitted can be custom formulated to the specific application. For example, the repellent can be weak or strong and have a long or short-term life span. In certain applications, such as a maximum-security prison, other chemicals such as pepper spray can be added to or substituted for the benign substance.

The repellent substance can consist of an infinite number of chemicals, including but not limited to, benign color dyes, mixtures that have a bad odor, pepper spray or other substances.

It is recognized that some intruders will wear protective clothing in an attempt to diminish the effectiveness of the emission. Such clothing will not be available to most intruders and counter-productive if the correct type of barrier is employed.

### CONCLUSIONS AND RAMIFICATIONS

The axiom of good perimeter security protection consists of three words—Deter, Detect and Delay. There have been hundreds of various types of electronic sensors developed to detect intruders. Likewise, there are hundreds of delay methods, usually in the form of barriers such as fences or walls. There are several types of deterrents and they come in many forms. The most common, barbed wire and razor-ribbon, are well known. Even though they can cause physical harm, they are easy to defeat.

Lethal and non-lethal electric fencing have tremendous deterrent value but are outlawed for most applications and they are also relatively easy to defeat by simply shorting or cutting a few wires.

If a perimeter security system has sufficient deterrence to dissuade the intruder from attempting a breach of the perimeter fence and the system is also impervious to vandalism that would defeat the deterrent component, the costs associated with the detection, delay, response, and apprehension drops dramatically. If apprehension results in judicial proceedings and incarceration, the cost savings are that much greater.

The perfect example of this is described in the “Background” paragraph and it also applies to any other perimeter security application.

Offensive odors are an excellent deterrent as proven by the well-known fact that people fear being sprayed by a skunk.

A second advantage of my invention as a breaching deterrent is that it greatly helps to identify the intruder. If color is added to the emitted substance, the intruder can readily be identified by both visual and odor means. The intruder cannot quickly blend into the general public. Further, if there is reason to believe that the intruder will successfully breach the Border regardless of the repellent, the odor can be formulized to aid in tracking by dogs.

While the above description contains many specificities, these should not be construed as limitations on the scope of any embodiment, but as exemplifications of the presently preferred embodiments thereof. Many other ramifications and variations are possible within the teachings of the various embodiments. For example, the invention is not restricted to any specific type of barrier. It could be used with solid walls, chain link fences or any other barriers intended to create a line of demarcation and prevent intrusion from one side to the other.

In the embodiments shown in FIGS. 1 and 2, the distribution pipe and sensors may be located at the top of the fence (2) such that intruders will be sprayed if they climb the fence to vandalize the system, a major advantage of the invention. However, an obvious alternate approach would be to bury pipes underground and hide the emitters in the earth much like lawn sprinkler systems.

The sensor (8) shown in FIGS. 1 and 2 has been arbitrarily shown as being attached to the fence fabric. The invention is not limited to any type of sensors or their location. There are thousands of perimeter security sensor types such as seismic, pressure, infrared, microwave, fiber-optic, capacitance, etc.

Testing

Each type of sub-system, defined and described in this invention, consists of known, fully tested products or components that are within the state of the art. They need only to be engineered and properly assembled and installed by technicians that are familiar with that specific discipline. These subsystems include:
a. Repulsive odor repellents used to repel various types of animals from garden plants as manufactured by Liquid Fence Co. of Brodheadsville, Pa.
b. The PLC, that is the “brain” of any SCADA system, is readily available from a multitude of sources such as GE and Allen Bradley distributors.
c. Perimeter security sensors such as seismic, microwave, fiber-optic etc. are widely available from hundreds of security distributors nation-wide.

Sensors systems that can provide anomaly information within a few feet can be purchased from many perimeter security manufacturers such as Southwest Microwave, Tempe, Ariz.; Future Fiber Technologies, Mountain View, Calif. and Fiber Sensys, Inc., Portland, Oreg.

Fluid distribution and spraying systems such as those used for crop irrigation and fire retardant spraying systems are available from companies and distributors nation-wide.

I claim:

1. A deterrent to intrusion through a specified outdoor boundary line comprising:
a. A physical barrier
b. Electronic sensors capable of identifying their location
c. A programmable electronic digital processor
d. A repellent odor substance and dye
e. One or more substance reservoirs
f. Plumbing for a substance distribution system
g. Electrical valves for substance control
h. An electrical power grid
whereby the integration of these components into a perimeter security system as described in the specifications will inhibit and repel intrusion attempts.

2. A physical barrier in claim 1 consisting of a fence or wall.

3. Electronic sensors in claim 1 consisting of devices that will change state when an intruder disturbs the quiescent state of the sensor resulting from vibration, motion, magnetic, capacitance and other anomalies, said sensor being located in a pre-determined area or zone and said sensor sending a signal that includes the location of the breach attempt to a remote processor thereby allowing said processor to open pre-determined valves and limiting the emission of the repulsive substance to a localized area.

4. Means for repelling an intruder at a secure outdoor perimeter boundary by emitting a repellent substance at the point of the intrusion thereby inhibiting the intruder from crossing said perimeter boundary.

5. The use of a repellent substance in claim 4 that consists of a proven benign chemical mixture such as deer, dog or similar repellents to ensure that no harm results in spraying the intruder.

6. The optional use of a repellent substance in claim 4 that contains a proven benign color dye in the said substance so as to make the intruder identifiable if the intruder breaches the boundary.

7. Means for locating and identifying one or more intruders because of their smell and appearance, such condition resulting from being sprayed with and an odoriferous substance and color dye.

8. Said means in claim 7 wherein the odor consists of chemicals that are specifically formulated to facilitate dog tracking of intruders who have come in contact with said odoriferous substance.

9. Said means in claim 7 wherein the color dye, sprayed at the point of the intrusion attempt, assists responding personnel to identify the precise location of the intrusion as might be done by aircraft.
